(19) United States
(12) Patent Application Publication
(10) Pub. No.: US 2013/0067719 A1
(43) Pub. Date: Mar. 21, 2013

(54) DOOR MIRROR

(71) Applicants: Kentaro Suzuki, Fujieda-shi (JP); Takahiro Tsuchiya, Fujieda-shi (JP)

(72) Inventors: Kentaro Suzuki, Fujieda-shi (JP); Takahiro Tsuchiya, Fujieda-shi (JP)

(73) Assignee: MURAKAMI CORPORATION, Shizuoka (JP)

(21) Appl. No.: 13/560,460

(22) Filed: Jul. 27, 2012

(30) Foreign Application Priority Data
Sep. 20, 2011 (JP) 2011-205286

(51) Int. Cl. B23P 11/00

(52) U.S. Cl. 29/525.01

(57) ABSTRACT

A door mirror fabricating method includes the steps of fixing a mirror surface angle adjusting unit to a back face of a mirror holder to thereby configure a mirror unit assembly, accommodating the mirror unit assembly into a mirror housing from a side of a mirror exposure opening of the mirror housing, bringing a back face of the mirror surface angle adjusting unit of the mirror unit assembly and an inner face of the mirror housing into contact with each other, and fixing the mirror unit assembly to the mirror housing by fixing a fastening component penetrated through the mirror housing to the mirror surface angle adjusting unit from a side of the mirror housing opposed to the mirror exposure opening.

### CROSS-REFERENCE TO RELATED APPLICATIONS

This application claims priority to Japanese Patent Applications No. 2011-205286 filed on Sep. 20, 2011, the entire contents of which are incorporated by reference herein.

### BACKGROUND OF THE INVENTION

1. Field of the Invention

The present invention relates to a method of fabricating a door mirror which includes a mirror surface angle adjusting unit for adjusting an angle of a mirror holder that is fixed with a mirror.

2. Related Background of the Invention

In a prior art, there is Japanese Patent Laid-Open No. 2005-238954 as a technology in such a field. A door mirror described in the publication includes a mirror surface angle adjusting unit for adjusting an angle of a mirror holder which is made of a resin and fixed with a mirror, the mirror surface angle adjusting unit is accommodated in a mirror body (mirror housing), and the mirror is exposed from a mirror exposure opening of the mirror body. The mirror surface angle adjusting unit can adjust the mirror to an arbitrary angle by driving two motors at inside thereof, and is fixed to the mirror body by a screws from a side of the mirror exposure opening of the mirror body. Thereafter, the mirror surface angle adjusting unit and the mirror holder are integrated by inserting claw portions provided at a back face of the mirror holder to groove portions of a pivot plate of the mirror surface angle adjusting unit.

### SUMMARY OF THE INVENTION

### Problems that the Invention is to Solve

According to the door mirror fabricating method described above, the mirror surface angle adjusting unit is fixed to the mirror body by the screws from the side of the mirror exposure opening of the mirror body, and thereafter, the mirror holder is fixed to the mirror surface adjusting unit. However, when the mirror holder is fixed to the mirror surface angle adjusting unit by visual observation, it is extremely difficult to fit the claw portions that are disposed on the back face side of the mirror holder to the groove portions of the pivot plate of the mirror surface angle adjusting unit, and an assembling operation performance is obliged to depend on perception, which extremely deteriorates the assembling operation performance. The reason is as follows. The mirror surface angle adjusting unit which is fixed to the mirror body by the screws is in a state of being brought deeply into the mirror body. Furthermore, the mirror holder has a shape of a large plate which substantially covers the mirror exposure opening of the mirror body. Therefore, when the assembling operation is carried out by visual observation, unless the mirror surface angle adjusting unit is tilted to a position which is near to a limit, a state of fitting the claw portions which are disposed on the back face side of the mirror holder to the groove portions of the pivot plate of the mirror surface angle adjusting unit cannot visually be recognized, and an operator is forced to carry out an operation of peeping into the state from a small gap. In this way, the troublesome operation of assembling the mirror surface angle adjusting unit and the mirror holder causes to deteriorate the assembling operation performance of the door mirror.

It is an object of the present invention to provide a door mirror fabricating method having an excellent assembling operation performance.

### Means to Solve the Problems

The present invention is characterized in that a door mirror fabricating method of fabricating a door mirror configured by incorporating a mirror holder fixed with a mirror, and a mirror surface angle adjusting unit for adjusting an angle of the mirror holder into a mirror housing, and exposing the mirror from a mirror exposure opening of the mirror housing, includes the steps of:

fixing the mirror surface angle adjusting unit to a back face of the mirror holder to thereby configure a mirror unit assembly;

accommodating the mirror unit assembly into the mirror housing from a side of the mirror exposure opening of the mirror housing;

bringing a back face of the mirror surface angle adjusting unit of the mirror unit assembly and an inner face of the mirror housing into contact with each other; and

fixing the mirror unit assembly to the mirror housing by fixing a fastening component penetrated through the mirror housing to the mirror surface angle adjusting unit from a side of the mirror housing opposed to the mirror exposure opening.

The door mirror fabricating method proceeds to steps of, first, fixing the mirror surface angle adjusting unit to the back face of the mirror holder to thereby configure the mirror unit assembly, and fixing the mirror unit assembly to the mirror housing by using the fastening component. That is, according to the present invention, the mirror unit assembly is accommodated into the mirror housing from the side of the mirror exposure opening of the mirror housing, and thereafter, the back face of the mirror surface angle adjusting unit of the mirror unit assembly and the inner face of the mirror housing are brought into contact with each other. Under the state, the mirror unit assembly is fixed to the mirror housing by fixing the fastening component penetrated through the mirror housing to the mirror surface angle adjusting unit from the side of the mirror housing opposed to the mirror exposure opening (that is, a front side of the mirror housing when the side of the mirror exposure opening of the mirror housing is defined as a rear side). According to the present invention, a fastening operation of the fastening component is carried out from the side of the mirror housing opposed to the mirror exposure opening, and therefore, there is no troublesome operation as in the prior art, and an excellent assembling operation performance can be realized.

Further, the back face of the mirror holder is provided with two positioning protrusions having a circular section arranged to be remote from each other, and a tip end of a position adjusting jig is provided with a clamp portion for clamping the positioning protrusion, and the clamp portions of the position adjusting jigs arranged to be opposed to each other are moved to be proximate to each other along a linear line connecting the two positioning protrusions, and the positioning protrusions are clamped by the clamp portions to thereby position the mirror unit assembly.

The mirror unit assembly can accurately and firmly be positioned with the mirror of the mirror unit assembly placed on the downside and the mirror surface angle adjusting unit placed on the upside by using the position adjusting jig. Therefore, the back face of the mirror surface angle adjusting unit of the mirror unit assembly and the inner face of the mirror housing can be brought into contact with each other accurately at a prescribed position by covering the mirror housing over the mirror unit assembly after the positioning. Further, the fastening operation of the fastening component can firmly be carried out from above the mirror housing.

Further, the positioning protrusion is provided at a vicinity of an outer peripheral edge of the mirror holder.

When such a configuration is adopted, a distance between a center of the mirror holder and the positioning protrusion can be prolonged, and therefore, a positioning accuracy of the mirror unit assembly can be increased.

Further, the back face of the mirror surface angle adjusting unit is brought into contact with a partition wall provided in the mirror housing, and the partition wall is formed with an opening portion for exposing a terminal portion provided at the back face of the mirror surface angle adjusting unit, and after fixing the mirror unit assembly to the partition wall of the mirror housing by the fastening component, a connector portion of a harness used for supplying an external electric power is connected to the terminal portion through the opening portion.

The connection of the harness used for supplying the external electric power and the mirror surface angle adjusting unit can be carried out after fastening the mirror housing and the mirror unit assembly by adopting such a configuration. Particularly, in the door mirror which is provided with a cover member (ordinarily painted with a color the same as that of a body of a vehicle) on a front side of the mirror housing, the connector portion of the harness and the terminal portion of the mirror surface angle adjusting unit can easily be connected from the front side of the mirror housing, which also helps to realize the excellent assembling operation performance.

Further, an insertion hole for inserting the fastening component is formed at a surrounding of the opening portion, and the back face of the mirror surface angle adjusting unit is formed with a fixing hole enabling to fix the fastening component at a position in correspondence with the insertion hole.

Downsizing of the back face of the mirror surface angle adjusting unit can be achieved by arranging the insertion hole at the surrounding of the opening portion for exposing the terminal portion in this way, which contributes to downsizing of the mirror surface angle adjusting unit.

### Advantage of the Invention

According to the present invention, the assembling operation performance of the door mirror is improved.

### BRIEF DESCRIPTION OF THE DRAWINGS

FIG. 1 is a front view showing an embodiment of a door mirror to which a fabricating method according to the present invention is applied.

FIG. 2 is a disassembled perspective view of the door mirror.

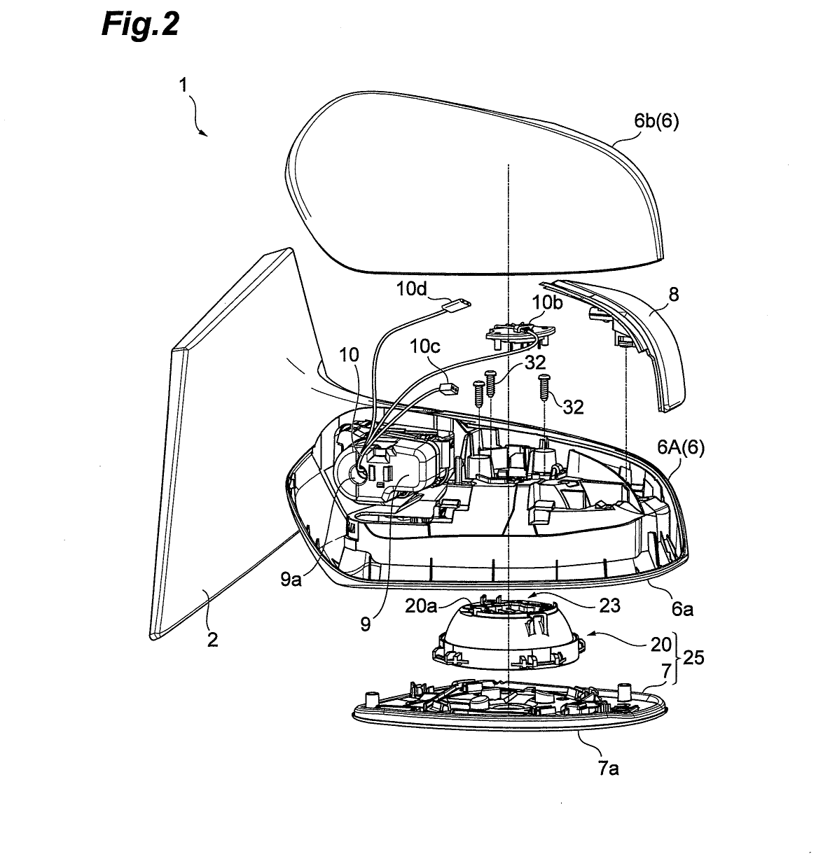

FIG. 3 is a disassembled perspective view of a mirror unit assembly.

FIG. 4 is a sectional view of the door mirror.

FIG. 5 is a front view showing a housing main body of a mirror housing.

FIG. 6 is a plan view showing a relationship between the mirror unit assembly and a position adjusting jig.

FIG. 7 is a sectional view configured by disassembling the door mirror in an up and down direction.

FIG. 8 is a sectional view showing other example of a door mirror.

### DESCRIPTION OF THE PREFERRED EMBODIMENTS

A detailed explanation will be given of a preferred embodiment of a door mirror fabricating method according to the present invention with reference to the drawings as follows. Incidentally, “front and rear” in a door mirror 1 is expressed in accordance with a front and rear direction of a vehicle.

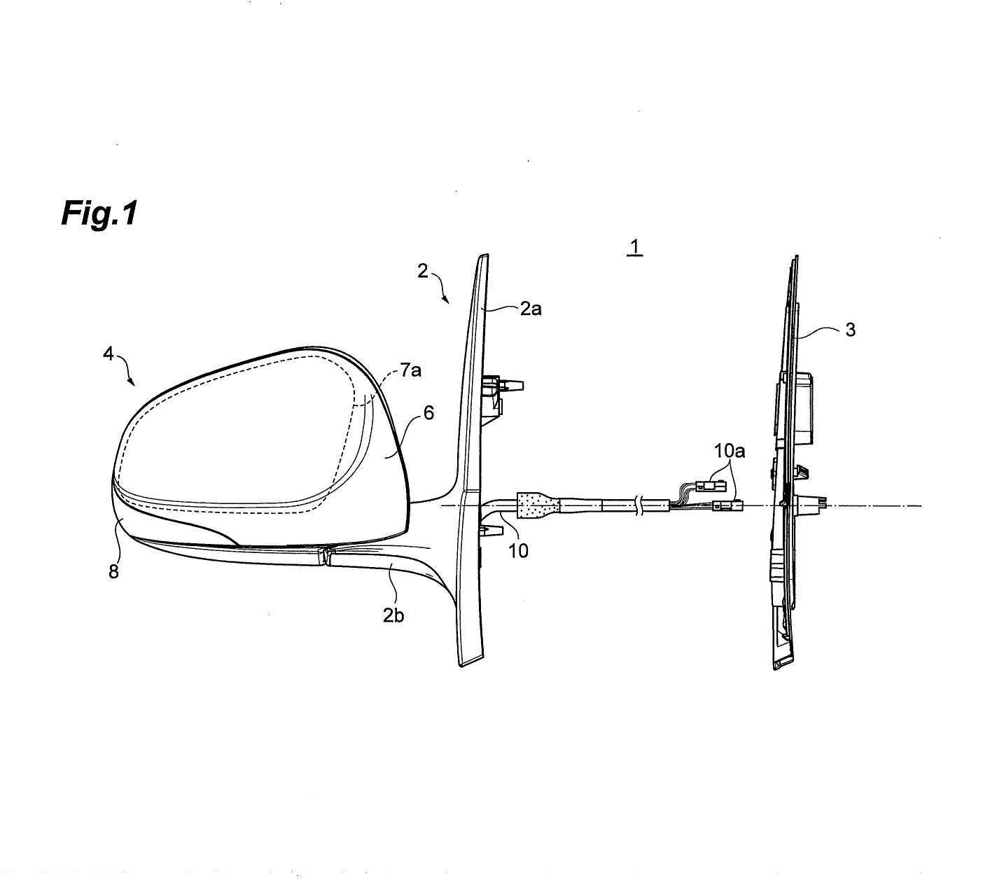

As shown in FIG. 1, the electric door mirror 1 is mainly configured by a door mirror base 2 which is fixed to a front door of a vehicle by bolts, a gasket 3 which is attached to a base main body 2a of the door mirror base 2 to achieve a seal function by being brought into close contact with the front door, and a door mirror main body 4 which is pivotably attached to a pedestal portion 2b of the door mirror base 2.

The door mirror main body 4 includes a mirror holder 7 which is arranged on a side of a mirror exposure opening 6a of a mirror housing 6, a mirror surface angle adjusting unit 20 which is fitted to a back face 7f of the mirror holder 7 that is fixed with a mirror 7a on a surface side for adjusting an angle of the mirror holder 7, an electric storage unit 9 which is connected to the pedestal portion 2b of the door mirror base 2 for bringing the door mirror main body 4 into a storage state by pivoting the door mirror main body 4 per se, and a turn lamp unit 8 which is fixed to the mirror housing 6.

Further, the electric door mirror 1 is provided with a harness 10 which is wired around in the door mirror base 2 and the door mirror main body 4 for supplying power respectively to motors in the mirror surface angle adjusting unit 20, a motor in the electric storage unit 9, and a lamp in the turn lamp unit 8. The harness 10 is exposed to outside from the gasket 3 which is attached to the base main body 2a of the door mirror base 2. At one end of the harness 10, there is provided a connector portion 10a for connecting to wirings in the vehicle, and at the other end of the harness 10, there are provided a connector portion 10b which is connected to the mirror surface angle adjusting unit 20, a connector portion 10c which is connected to the electric storage unit 9, and a connector portion 10d which is connected to the turn lamp unit 8.

Further, the electric door mirror 1 is provided with a cover member 6b which forms a portion of the mirror housing 6. The cover member 6b is ordinarily painted with a color the same as that of the body of the vehicle, and is disposed on a front side of the mirror housing 6. The mirror housing 6 is configured by a housing main body 6A for accommodating the mirror surface angle adjusting unit 20 and the electric storage unit 9, and the cover member 6b. Further, the electric storage unit 9 is fixed to the housing main body 6A and includes a harness drawing hole 9a for passing the harness 10.

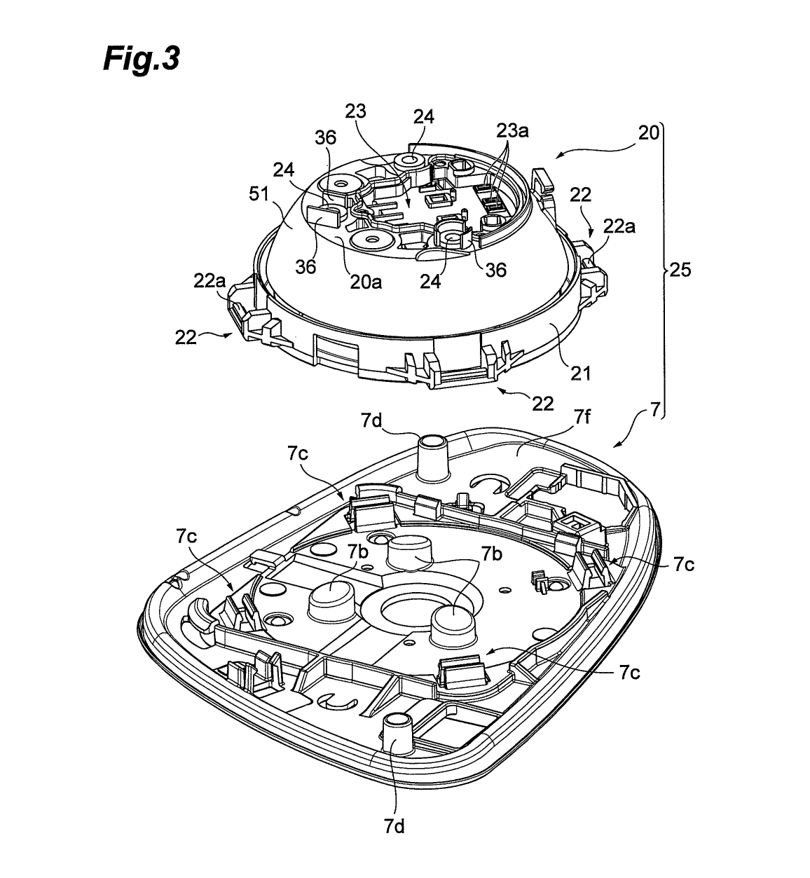

As shown in FIG. 3, the back face 7f of the mirror holder 7 is formed with four clamp claw portions 7c which are protruded for enabling to fix the mirror surface angle adjusting unit 20, and three protruded portions 7b enabling to position the mirror surface angle adjusting unit 20 relative to the mirror holder 7. Further, at the back face 7f of the mirror holder 7, the four clamp claw portions 7c are arranged at equal intervals in a peripheral direction on an outer side of the three protruded portions 7b.

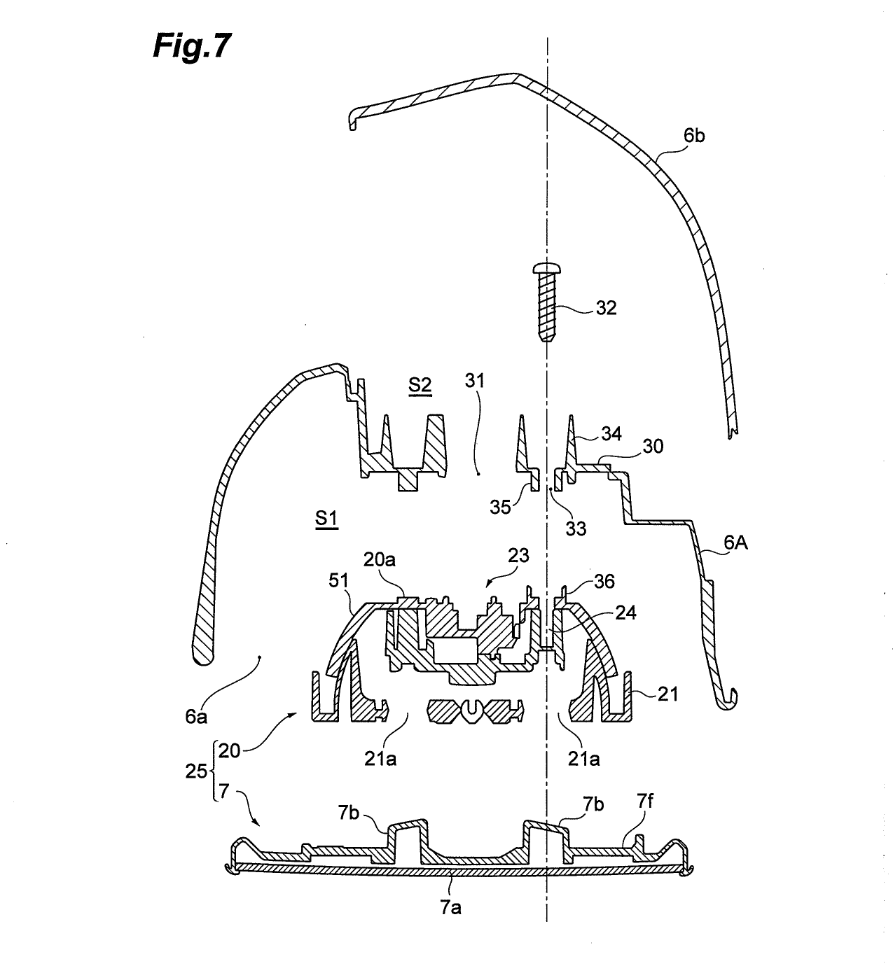

A tiltable pivot plate 21 which is provided at the mirror surface angle adjusting unit 20 has a circular outer periphery, and the pivot plate 21 is formed with catch portions 22 which are protruded in a diameter direction. Each of the catch portions 22 is provided with a catch bar 22a which is clamped by the clamp claw portion 7c of the mirror holder 7. Further, the pivot plate 21 of the mirror surface angle adjusting unit 20 is formed with positioning holes 21a (refer to FIG. 7) for inserting the protruded portions 7b of the mirror holder 7 respectively.

A back face 20a of the mirror surface angle adjusting unit 20 is provided with a terminal portion 23 in a recessed shape for connecting the connector portion 10b of the harness 10, and in the terminal portion 23 feeding terminals 23a on a female side are arranged. Furthermore, female screw holes 24 are arranged at a surrounding of the terminal portion 23 having the recessed shape. Incidentally, a mirror unit assembly 25 is configured by integrating the mirror holder 7 and the mirror surface angle adjusting unit 20 by cooperatively operating the clamp claw portions 7c and the catch bars 22a.

There are provided the four feeding terminals 23a, two of which are connected to a first motor (not illustrated) in the mirror surface angle adjusting unit 20, and the other two of which are connected to a second motor (not illustrated) in the mirror surface angle adjusting unit 20. Incidentally, the first motor tilts the mirror surface in a vertical direction, and the second motor tilts the mirror surface in a horizontal direction.

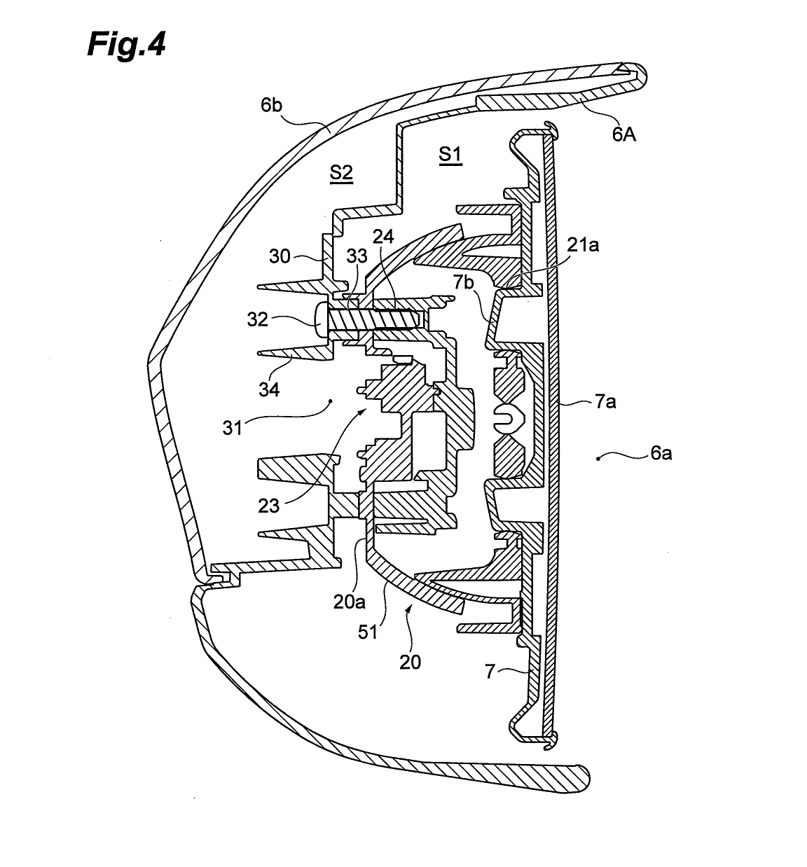

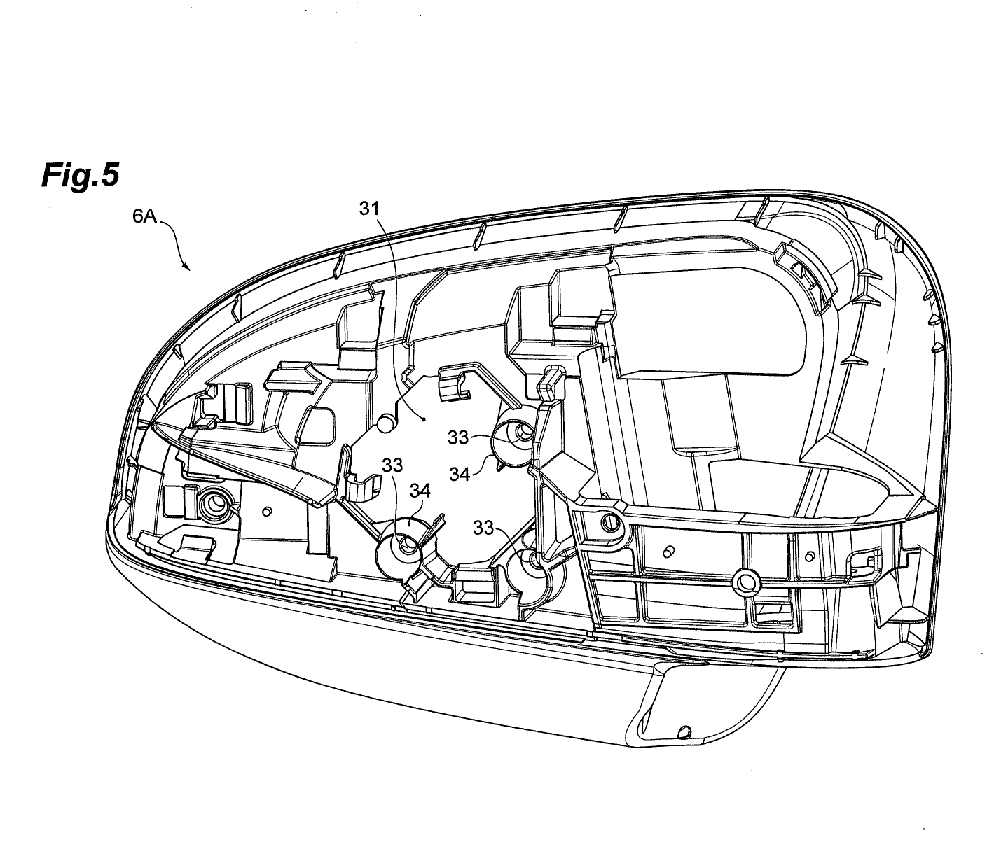

As shown in FIG. 4 and FIG. 5, the housing main body 6A of the mirror housing 6 is provided with a partition wall 30 for partitioning a mirror accommodating space (second space) S1 which is disposed on a rear side for accommodating the mirror unit assembly 25, and a harness accommodating space (first space) S2 which is disposed on a front side for accommodating the harness 10 which is drawn out from the mirror surface angle adjusting unit 20 to outside of the door mirror 1. Further, the harness accommodating space S2 is formed by cooperatively operating the partition wall 30 of the housing main body 6A and the cover member 6b, and the harness 10 is wired around in the harness accommodating space S2.

The partition wall 30 for fixing the mirror surface angle adjusting unit 20 is formed with an opening portion 31 for exposing the terminal portion 23 of the mirror surface angle adjusting unit 20, and an insertion hole 33 for inserting screws 32 as a fastening components are formed at a surrounding of the opening portion 31. Further, a reinforcing tube portion 34 which are erected from the partition wall 30 is provided at each surrounding of the insertion holes 33. In contrast thereto, the back face 20a of the mirror surface angle adjusting unit 20 is formed with female screw holes (fixing holes) 24 enabling to fix the screws 32 at positions in correspondence with the insertion holes 33. In this way, by arranging the insertion holes 33 at the surrounding of the opening portion 31 for exposing the terminal portion 23, the back face 20a of the mirror surface angle adjusting unit 20 can be downsized, which contributes to downsizing of a motor holder 51 of the mirror surface angle adjusting unit 20.

The back face 20a of the mirror surface angle adjusting unit 20 is brought into contact with the partition wall 30 of the housing main body 6A in a positioned state, and the screws 32 are inserted into the respective insertion holes 33 from the side of the harness accommodating space S2 in a state of exposing the terminal portion 23 of the mirror surface angle adjusting unit 20 from the opening portion 31 of the partition wall 30. The mirror unit assembly 25 is fixed to the partition wall 30 of the housing main body 6A by screwing the screws 32 with the respective female screw holes 24 of the mirror surface angle adjusting unit 20 and tightening the screws 32. After the screwing operation, the connector portion 10b of the harness 10 is connected to the terminal portion 23 of the back face 20a of the mirror surface angle adjusting unit 20 which is exposed from the opening portion 31.

Also, the connector portion 10c of the harness 10 is connected to the electric storage unit 9, and the connector portion 10d of the harness 10 is connected to the turn lamp unit 8. Further, the turn lamp unit 8 is screwed to the housing main body 6A, and thereafter, the cover member 6b is attachably and detachably fitted to a front face side of the housing main body 6A.

Next, an explanation will be given of a method of assembling the electric door mirror 1.

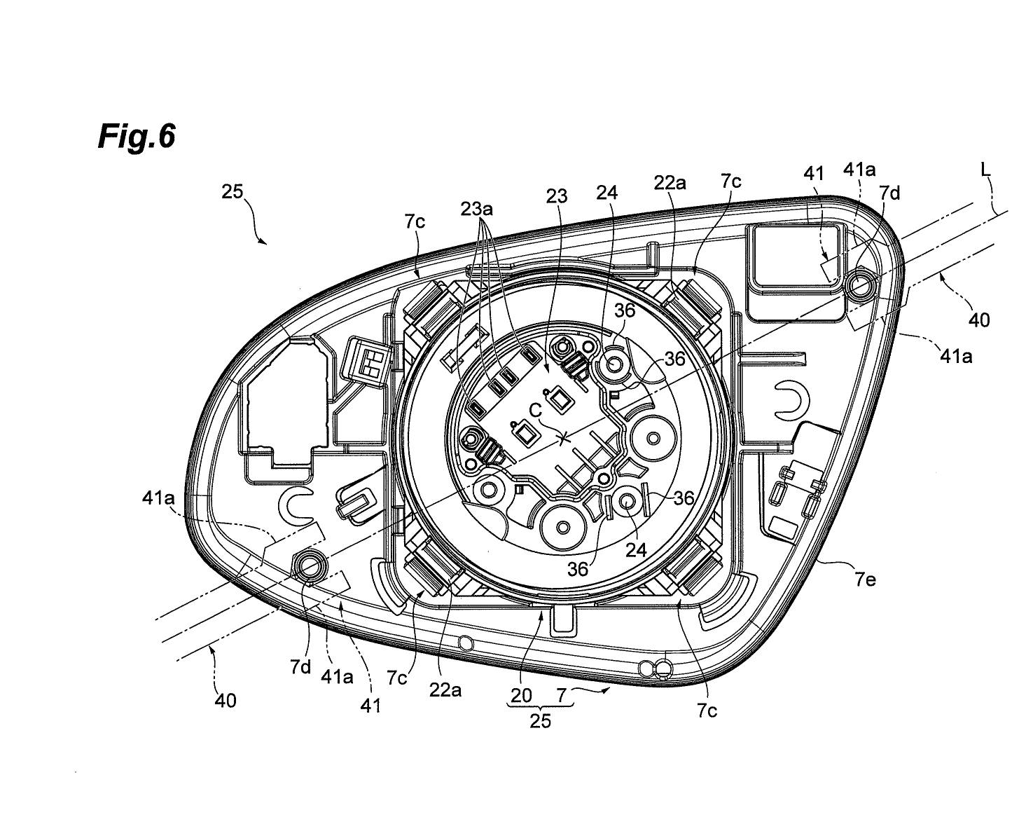

As shown in FIG. 6, the mirror unit assembly 25 is held by position adjusting jigs 40 with the mirror 7a placed downside. In this case, at the back face 7f of the mirror holder 7, there are provided a pair of positioning protrusions 7d having a circular section which are arranged opposedly to each other with a center C as a boundary on a linear line L which passes through a center (that is, gravity center) C of the mirror holder 7. Also, there are respectively provided clamp portions 41 for clamping the respective positioning protrusions 7d at tip ends of the respective position adjusting jigs 40. The clamp portion 41 has bifurcated finger portions 41a, and the positioning protrusion 7d is clamped between the finger portions 41a. Furthermore, the respective position adjusting jigs 40 are reciprocally moved along the linear line L which connects centers of the pair of positioning protrusions 7d by a linear actuator (not illustrated). Further, when an interval between the two positioning protrusions 7d is equal to or more than 50 mm, stable positioning can be carried out.

The clamp portions 41 of the position adjusting jigs 40 which are arranged opposedly to each other are moved to be proximate to each other from outer sides toward the center C along the linear line L which connects centers of the pair of positioning protrusions 7d, and clamp the positioning protrusions 7d by the finger portions 41a of the clamp portions 41 to thereby position the mirror unit assembly 25.

The mirror unit assembly 25 can accurately and firmly be positioned with the mirror 7a of the mirror unit assembly 25 placed downside and the mirror surface angle adjusting unit 20 placed upside by using such position adjusting jigs 40. Further, the back face 20a of the mirror surface angle adjusting unit 20 of the mirror unit assembly 25 and an inner face of the mirror housing 6 can be brought into contact with each other accurately at a prescribed position by covering the mirror housing 6 over the mirror unit assembly 25 after the positioning. As a result thereof, an operation of screwing the screws 32 as the fastening components can firmly be carried out from above the mirror housing 6.

Furthermore, the positioning protrusion 7d is provided at a vicinity of the outer peripheral edge 7e of the mirror holder 7. When such a configuration is adopted, a distance between the center C and the positioning protrusion 7d can be made to be long, by which a positioning accuracy of the mirror unit assembly 25 can be increased.

As shown in FIG. 7, the mirror unit assembly 25 is accommodated in the mirror accommodating space S1 by inserting the mirror unit assembly 25 into the mirror exposure opening 6a of the mirror housing 6 from above the mirror unit assembly 25 which has been positioned in this way. Furthermore, the back face 20a of the mirror surface angle adjusting unit 20 is brought into contact with the partition wall 30 which is provided in the housing main body 6A, and the terminal portion 23 is exposed from the opening portion 31 of the partition wall 30.

At this occasion, the partition wall 30 is formed with circular tube portion 35 each of which has the insertion hall 33 at an inner portion thereof and is projected to the side of the mirror accommodating space S1. The back face 20a of the mirror surface angle adjusting unit 20 is formed with plural convex pieces 36 which are disposed at surroundings of the female screw holes 24. Therefore, a peripheral face of the circular tube portions 35 are brought into contact with the plural convex pieces 36. Therefore, the housing main body 6A and the mirror unit assembly 25 are positioned. Incidentally, the operation described above is carried out under a state that the door mirror base 2 was attached to the mirror housing 6.

Thereafter, the screws 32 are inserted into the respective insertion holes 33 from an opposite side of the mirror exposure opening 6a of the mirror housing 6, that is, from above, and the screws 32 are screwed with the respective female screw holes (fixing holes) 24 of the mirror surface angle adjusting unit 20 by penetrating the mirror housing 6 to thereby fix the mirror unit assembly 25 to the partition wall 30. Incidentally, the opposite side of the mirror exposure opening 6a of the mirror housing 6 also signifies a side being scheduled to mount the cover member 6b, or the side of the harness accommodating space S2.

Thereafter, the connector portion 10b of the harness 10 which is used for supplying an external electric power is connected to the terminal portion 23 through the opening portion 31. The connection of the harness 10 which is used for supplying an external electric power and the mirror surface angle adjusting unit 20 can be carried out after fastening the mirror housing 6 and the mirror unit assembly 25 by adopting such a configuration. Particularly, the connector portion 10b of the harness 10 and the terminal portion 23 of the mirror surface angle adjusting unit 20 can easily be connected from the upside of the mirror housing 6 in the case of the door mirror which is provided with the cover member 6b (ordinarily, painted with a color the same as that of the body of the vehicle) on the front side of the mirror housing 6, which helps to realize the excellent assembling operation performance.

The door mirror fabricating method proceeds to steps of, first, fixing the mirror surface angle adjusting unit 20 to the back face 7f of the mirror holder 7 to thereby configure the mirror unit assembly 25, and fixing the mirror unit assembly 25 to the mirror housing 6 by using the screws 32. That is, the mirror unit assembly 25 is accommodated in the mirror housing 6 from the side of the mirror exposure opening 6a of the mirror housing 6, and thereafter, the back face 20a of the mirror surface angle adjusting unit 20 of the mirror unit assembly 25 and the inner face of the mirror housing 6 are brought into contact with each other.

Under the state, the mirror unit assembly 25 is fixed to the mirror housing 6 by fixing the screws 32 which penetrate the mirror housing 6 to the mirror surface angle adjusting unit 20 from the opposite side of the mirror exposure opening 6a of the mirror housing 6 (that is, the front side of the mirror housing 6 when the side of the mirror exposure opening 6a of the mirror housing 6 is defined as the rear side). According to the door mirror 1, the operation for tightening the screws 32 is carried out from the opposite side of the mirror exposure opening 6a of the mirror housing 6 (that is, upside). Therefore, there is no troublesome operation as in the prior art, and an excellent assembling operation performance can be realized.

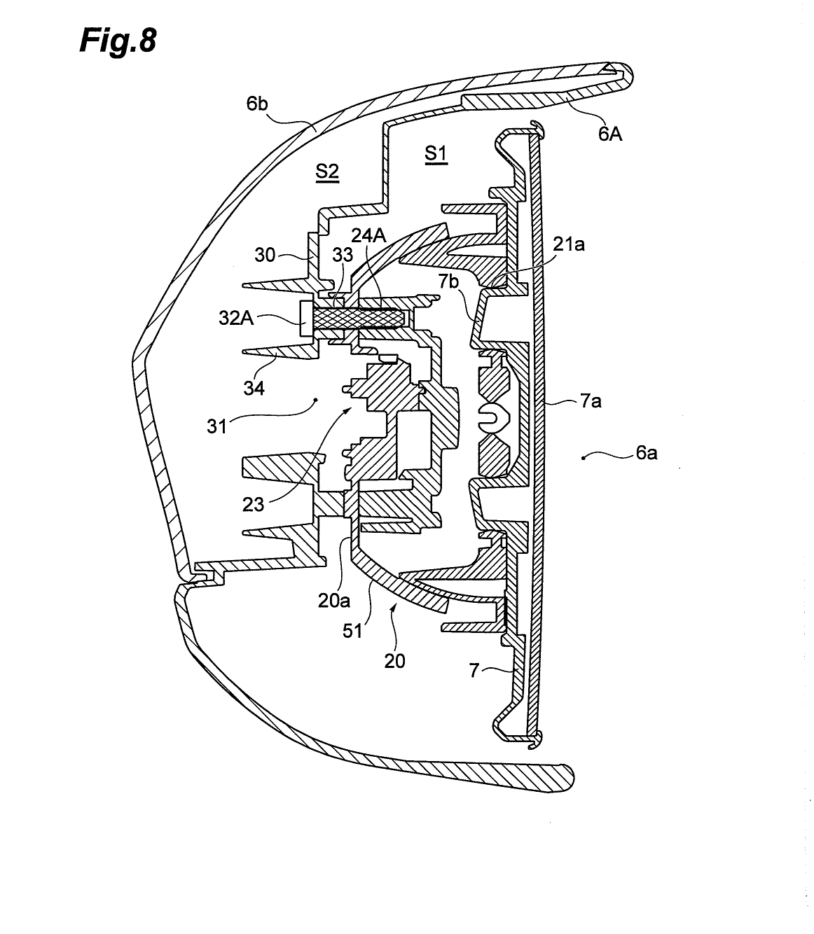

The present invention is not naturally limited to the embodiment described above. For example, the fastening component is not limited to the screw but may be a driving fit pin 32A as shown in FIG. 8. In this case, the mirror surface angle adjusting unit 20 is formed with a press fit hole (fixing hole) 24A.

What is claimed is:

1. A door mirror fabricating method of fabricating a door mirror configured by incorporating a mirror holder fixed with a mirror, and a mirror surface angle adjusting unit for adjusting an angle of the mirror holder into a mirror housing, and exposing the mirror from a mirror exposure opening of the mirror housing, the door mirror fabricating method comprising the steps of:
fixing the mirror surface angle adjusting unit to a back face of the mirror holder to thereby configure a mirror unit assembly;
accommodating the mirror unit assembly into the mirror housing from a side of the mirror exposure opening of the mirror housing;
bringing a back face of the mirror surface angle adjusting unit of the mirror unit assembly and an inner face of the mirror housing into contact with each other; and
fixing the mirror unit assembly to the mirror housing by fixing a fastening component penetrated through the mirror housing to the mirror surface angle adjusting unit from a side of the mirror housing opposed to the mirror exposure opening.

2. The door mirror fabricating method according to claim 1, wherein the back face of the mirror holder is provided with two positioning protrusions having a circular section arranged to be remote from each other, and a tip end of a position adjusting jig is provided with a clamp portion for clamping the positioning protrusion; and
wherein the clamp portions of the position adjusting jigs arranged to be opposed to each other are moved to be proximate to each other along a linear line connecting the two positioning protrusions, and the positioning protrusions are clamped by the clamp portions to thereby position the mirror unit assembly.

3. The door mirror fabricating method according to claim 2, wherein the positioning protrusion is provided at a vicinity of an outer peripheral edge of the mirror holder.

4. The door mirror fabricating method according to claim 1, wherein the back face of the mirror surface angle adjusting unit is brought into contact with a partition wall provided in the mirror housing, and the partition wall is formed with an opening portion for exposing a terminal portion provided at the back face of the mirror surface angle adjusting unit; and
wherein after fixing the mirror unit assembly to the partition wall of the mirror housing by the fastening component, a connector portion of a harness used for supplying an external electric power is connected to the terminal portion through the opening portion.

5. The door mirror fabricating method according to claim 4, wherein an insertion hole for inserting the fastening component is formed at a surrounding of the opening portion, and the back face of the mirror surface angle adjusting unit is formed with a fixing hole enabling to fix the fastening component at a position in correspondence with the insertion hole.
